(19) United States
(12) Patent Application Publication
(10) Pub. No.: US 2006/0023271 A1
(43) Pub. Date: Feb. 2, 2006

(54) Scanner with color profile matching mechanism

(76) Inventors: Yoke Peng Boay, Penang (MY); Kean Loo Keh, Penang (MY); Chin Hin Oon, Penang (MY); Selvan Maniam, Penang (MY); King Wai Wong, Penang (MY)

Correspondence Address: AGILENT TECHNOLOGIES, INC.;Intellectual Property Administration, Legal Department, DL429, P.O. Box 7599, Loveland, CO, 80537-0599, US

(21) Appl. No.: 10/902,999

(22) Filed: Jul. 30, 2004

(51) Int. Cl. H04N 1/46

(52) U.S. Cl. 358/504

(57) ABSTRACT

Scanner with light source calibration mechanism. The scanner includes a light source that generates a white light utilized to scan an image. The light source calibration mechanism includes a calibration color sensor that generates a calibration color sensor output. The light source calibration mechanism receives a predetermined color profile that can be, for example, the amount of red, green light, and blue light expected from the light source utilized by the scanner for scanning. The color calibration mechanism calibrates the light source of the scanner based on the output of the calibration color sensor and the predetermined color profile.

### BACKGROUND OF THE INVENTION

Image scanning devices such as, for example, flat bed image scanners and sheet feed image scanners, are commonly used to scan documents containing image information to convert the image information contained on the document into a digital representation of the document. Image scanning devices typically utilize a linear imaging device, which is scanned across a document being imaged to produce multiple one-dimensional (1-D) slices of the image, which are subsequently processed and combined to produce a two-dimensional (2-D) digital representation of the image contained on the document.

The image scanning device utilizes a light source to project light onto the document being scanned. The light reflected from the document is focused by imaging optics onto the linear imaging device. The linear imaging device includes one or more photo sensors that convert the light reflected from the document into analog signals. The analog signals are then converted by an analog-to-digital converter into a digital representation. The digital representation is then processed by a processing circuit such as, for example, a microprocessor or a digital signal processor in accordance with a predetermined algorithm to produce an output. The output may be, for example, a reproduction of the original image scanned.

Generally, image scanning devices can be categorized into two categories: 1) image scanning devices that utilize an optical reduction system in combination with a single photo sensor (hereinafter “reduction scanners”); and 2) image scanning devices that utilize a contact image sensor (CIS) that includes a plurality of photo sensors in combination with an array of optical fibers that function as the imaging optics (hereinafter “CIS scanners”).

One problem encountered for the above scanner systems is the deterioration or degradation of the light source. The light source can be implemented with three color light emitting diodes (LEDs) and a light guide that mixes the three light components to generate a white light.

A light emitting diode (LED) generates a predetermined amount of light when a particular amount of current is passed there through. For example, a red light emitting diode (LED) generates a predetermined amount of light under certain conditions (e.g., input current). Unfortunately, upon the passage of time, the performance of the LED (e.g., red LED) degrades or deteriorates so that the LED generates less red light than the LED originally generated. When the LED was new, for example, the red LED provides 20 k LUX (lumens (lm) per square meter) of red light when supplied with 1 mA of current. However, after the passage of time, the red LED may provide only 15 k LUX of red light instead of 20 k LUX when supplied with the same 1 mA of current.

It is noted that the output of the light source of the scanner is ideally a white light. The white light is generated by mixing a red light, green light, and a blue light by employing a light guide. When one or more of the components of the white light is more than or less than the other components, the white light is no longer white. For example, when the red LED generates less red light than previously, the resulting mixture of the red, green and blue light at the output of the light guide has a green component and a blue component that are greater than the portion of red component or light. Consequently, the resulting output light will not be white since it lacks intensity in red color.

As can be appreciated, when the light generated by the light source is not a pure white light, the scanner produces output images that do not accurately re-create the colors of the scanned image. Furthermore, degradation of the light source adversely affects scan quality of the scanner. For example, the color in the scanned image (e.g., color photograph) will not be accurately reproduced since the light directed thereto is not a white light but some other light that may lack. Consequently, the scanned version may not accurately reproduce the actual colors of the scanned image.

Based on the foregoing, there remains a need for a color calibration method and apparatus for scanners that that overcomes the disadvantages set forth previously.

### SUMMARY OF THE INVENTION

According to one embodiment of the present invention, a scanner with a light source calibration mechanism. The scanner includes a light source that generates a white light utilized to scan an image. The light source calibration mechanism includes a calibration color sensor for generating a calibration color sensor output. The light source calibration mechanism receives a predetermined color profile that can be, for example, the amount of red, green light, and blue light expected from the light source utilized by the scanner for scanning. The light source calibration mechanism calibrates the light source of the scanner based on the output of the calibration color sensor and the predetermined color profile.

According to another embodiment of the present invention, the color calibration mechanism is optionally coupled to an image sensor (e.g., a contact image sensor) to receive an image sensor output. The color calibration mechanism calibrates the light source of the scanner based on the output of the calibration color sensor, image sensor output, and the predetermined color profile.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a scanner that utilizes a color calibration mechanism according to one embodiment of the invention.

FIG. 2 illustrates in greater detail various aspects of the scanner of FIG. 1 according to one embodiment of the invention.

FIG. 3 is a flow chart illustrating the processing steps performed by the color profile matching mechanism according to one embodiment of the invention.

### DETAILED DESCRIPTION

Scanner with color profile matching mechanism is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Scanner 100

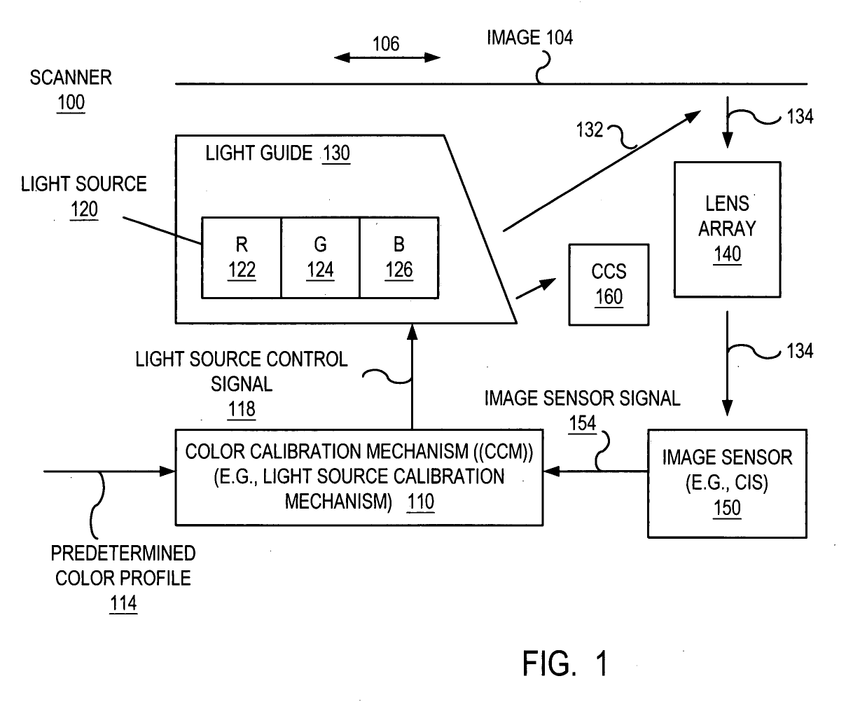

FIG. 1 illustrates a scanner 100 that utilizes a color calibration mechanism (CCM) 110 according to one embodiment of the invention. The scanner 110 scans images (e.g., image 104). The scanner 100 is configured to sense an image 104 that is disposed on the bottom surface of a document, for example. The image 104 is moved longitudinally in one of the directions shown by the double-sided arrow 106 so that a single scan line across the width of the document may be sensed at a time. The scanner includes a color calibration mechanism (CCM) 110, a light source 120, a light guide 130, a lens array 140, an image sensor 150, and a color calibration sensor (CCS) 160.

According to one embodiment of the present invention, a light source calibration mechanism 110 (also referred to herein as a color calibration mechanism (CCM)) is provided. The scanner includes a light source that generates a white light utilized to scan an image. The light source calibration mechanism includes a calibration color sensor for generating a calibration color sensor output. The color calibration mechanism receives a predetermined light source profile (e.g., a color profile) that can be, for example, represent the amount of red, green light, and blue light expected from the light source utilized by the scanner for scanning. The light source calibration mechanism calibrates the light source of the scanner based on the output of the calibration color sensor and the predetermined color profile.

According to another embodiment of the present invention, the light source calibration mechanism is optionally coupled to an image sensor (e.g., a contact image sensor) to receive an image sensor output. The light source calibration mechanism calibrates the light source of the scanner based on the output of the calibration color sensor, the image sensor output, and the predetermined color profile.

According to another embodiment of the present invention, the color calibration mechanism is optionally coupled to an image sensor (e.g., a contact image sensor) to receive an image sensor output. The image sensor output corresponds to an amount of light reflected from a reference image. The color calibration mechanism receives a predetermined color profile that corresponds to the reference image. The predetermined color profile can be, for example, the amount of red, green and blue light expected from scanning the reference image. The color calibration mechanism calibrates the color space of the scanner based on the output of the calibration color sensor, output provided by the image sensor, and the predetermined color profile. Calibration can include the step of adjusting the driver control signals for the light source.

The image 104 is illuminated by the light source 120 (also referred to herein as “illuminant”). Preferably, the light source 120 is implemented with a plurality of light-emitting diodes (LEDs). In one embodiment, the light source 120 includes a red (R) light emitting diode 122, a green (G) light emitting diode 124, and a blue (B) light emitting diode 126. The red (R) light emitting diode 122 generates a red light (i.e., light with a wavelength corresponding generally to the red region of the visible spectrum). The green (G) light emitting diode 124 generates a green light (i.e., light with a wavelength corresponding generally to the green region of the visible spectrum). The blue (B) light emitting diode 126 generates a blue light (i.e., light with a wavelength corresponding generally to the blue region of the visible spectrum). It is noted that the LEDs 122, 124, 126 may be of the same color or of different colors than the colors described above.

The CCM 110 generates one or more light source control signals 118 to control the light source 120. For example, light source control signals 118 can include a drive signal for each light emitting diode (LED). When provided to the LED, the drive signal (e.g., a drive current) causes the LED to generate a predetermined amount of light. For example, a red light emitting diode (red LED) generates a predetermined amount of light when supplied with a predetermined amount of drive current.

As noted previously, the performance of the LEDs 122, 124, 126 may degrade over time or due to other conditions (e.g., temperature variations in the operating environment). When the LED is new, for example, the red LED provides 20 k LUX of red light when supplied with 1 mA of drive current. However, after the passage of time, the red LED may provide only 15 k LUX of red light instead of 20 k LUX when supplied with the same 1 mA of drive current.

The light guide 130 combines the red light, green light and the blue light to produce a white light that is utilized to illuminate the image 104 to be scanned. For example, the light guide 130 optically mixes the R, G, B light to produce a white light and directs or channels the white light to the image.

Light from the LEDs travels along the path 132 from the LEDs 122, 124, 126 during a scan and impinges on the image 104 being scanned. The light reflects off the image 104 to be scanned and is focused onto the image sensor 150 by a lens array 140 (e.g., an array of lenses).

For example, the light passes along the line 134 through the lens array 140, which is preferably a molded plastic lens array, and is focused by the lens array 140 onto the image sensor 150 (e.g., an optical image sensing device). In this embodiment, the light guide 130, lens array 140, and image sensor 150 run across the entire length of the scan area (e.g., the entire width of a page to be scanned).

The color calibration mechanism (CCM) 110 calibrates the color space of the scanner 100 to a predetermined color profile 114. The predetermined color profile 114 can be, for example, a reference image, such as a white reference image. The CCM 110 tunes or calibrates the light source control signals 118 (e.g., R, G, B ratio) based on one or more of the following: the output of the image sensor, the output of the calibration color sensor, and the predetermined color profile 114 (e.g., characteristics of the reference image). In this manner, the CCM 110 provides an accurate and predictable mapping of the scanner's color space.

It is noted that the scanner 100 according to the invention may be incorporated, for example, in a facsimile machine, in a copier machine, in a scanning apparatus, in an all-in-one office machine, in a stand-alone unit, etc. It should be noted that the scanner 100 is merely one embodiment for carrying out the invention and that the CCM 110 according to the invention is not limited to any particular type of image scanning apparatus.

The image sensor 150 can be implemented with one or more optical image sensing devices. In one embodiment, the image sensor 150 is implemented as photo sensor arrays. Each photo sensor array can include one or more photo sensors (e.g., photo diode or photo transistor). Each of the photo sensors is connected to processing circuitry (not shown) that receives the electrical signals generated by the photo sensors in response to the light impinging thereon and processes the electrical signals into a form that is suitable for and that can be used by the particular image scanning device (e.g., facsimile machine, copier machine, etc.) in which the invention is incorporated.

Color Calibration Mechanism 110

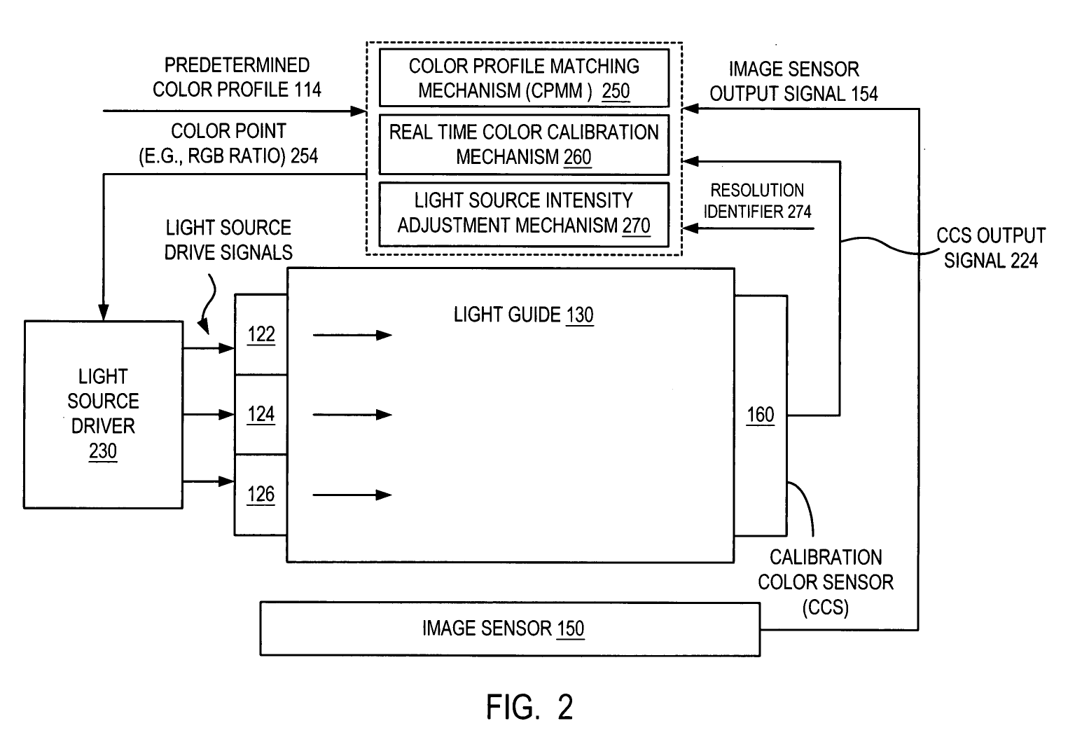

FIG. 2 illustrates in greater detail various aspects of the scanner 100 of FIG. 1 according to one embodiment of the invention. The scanner 100 includes a light source driver 230 that generates drive signals to activate, control, or drive the light source 120. When the light source includes light emitting diodes (e.g., a red LED 122, a green LED 124, and a blue LED 126), the light source driver 230 generates a respective or corresponding drive signal for each LED based upon a received color point 254.

The color point 254 can be, for example, a RGB ratio or a point in a color space, such as a chromaticity diagram defined by CIE 1931. CIE 1931 is a standard set by the International Commission on Illumination, which is abbreviated as CIE from its French title, Commission Internationale de l'Eclairage. The chromaticity diagram includes a horizontal axis for x-chromaticity coordinates and a vertical axis for y-chromaticity coordinates.

The color point 254 can be defined by a pair of values (e.g., in the form of (x, y)) that together specify a color point on the CIE chromaticity diagram. The CIE chromaticity diagram features monochromatic colors located on the perimeter and white light located in the center of the diagram. In one embodiment, the color point utilized is a white color point that is generally in the middle of the three major color regions, red, green and blue.

It is noted that as an LED in the light source 120 degrades or varies in performance due to conditions (e.g., temperature variations), the white color point tends to drift from the predetermined color point to another color point in the color space. In one example, when the performance of the red LED degrades and generates less red light than originally expected, the color point of the output light tends to drift to the green region (i.e., the color light output of the light source has less red and more green or blue).

The color calibration mechanism (CCM) 110 includes a color calibration sensor (CCS) 160 for generating a color calibration sensor output that represents the light generated by the light source. In one embodiment, the color calibration sensor (CCS) 160 includes a plurality of color sensors (e.g., a red color sensor, a green color sensor, and a blue color sensor). In another embodiment, the color calibration sensor 160 can be implemented with a single integrated circuit that receives light and generates three inputs: a first output signal (e.g., a first output voltage) representing the red component of the received light, a second output signal (e.g., a second output voltage) representing the green component of the received light, and a third output signal (e.g., a third output voltage) representing the blue component of the received light.

The color calibration mechanism (CCM) 110 also includes a color profile matching mechanism (CPMM) 250 for selectively adjusting the color point based on the output 154 of the image sensor, the output 224 of the calibration color sensor, and the predetermined color profile 114 that corresponds to a reference image. The predetermined color profile 114 can be, for example, described in terms of voltages or as a ratio. In one example, in an integrated circuit with an operating or supply voltage of 5V, white light can be described in terms of voltage by the following color profile 114: (R, G, B)=(2V, 2V, 2V). When the light source generates a light with greater intensity, the brighter white light can be described in terms of voltage by the following color profile 114: (R, G, B)=(4V, 4V, 4V). Alternatively, the white light can be described in terms of a ratio by the following color profile 114: (R, G, B)=(1, 1, 1). For an alternative profile, such as a red light profile, the profile may be described as follows: (R, G, B)=(1, 0.1, 0.1).

The color calibration mechanism (CCM) 110 according to the invention selectively controls the light source 120 (e.g., 122, 124, 126) to generate more or less of a particular color component in order to maintain a consistent light output (e.g., a consistent white light). The color calibration mechanism (CCM) 110 according to the invention detects the degradation of any of the color components of the white light generated by the light source 120 and automatically adjusts the control signals provided to the light source 120 (e.g., by adjusting the drive current supplied to one or more of the LEDs) to compensate for the degradation. For example, the drive current provided to the LED that is responsible for providing a particular color component in the white light can be increased. In response to the adjustment in drive current provided to the particular LED or LEDs, the color components are adjusted to levels that ensure a consistent white light output from the light guide 130.

For example, when the color calibration mechanism (CCM) 110 detects a degradation in the red light component, the CCM 110 automatically sends a signal to the light source driver 230, which can be implemented with a controller, to supply additional light source drive signals (e.g., extra drive current) to the red LED so that the red component matches with the green component and blue component, thereby providing a consistent white light (e.g., a white light that does not depend on operating conditions, such as temperature and age of light source 120).

In one embodiment, the color calibration mechanism 110 includes a real-time color calibration mechanism 260 to maintain a color point on a real-time basis. In this embodiment, the light source 120 is constantly monitored and the output of the CCS 220 is provided to the real-time color calibration mechanism 260 as feedback so that the real-time color calibration mechanism 260 can dynamically and automatically adjust the light source drive signals through light source driver 230, for example. In one embodiment, the real-time color calibration mechanism 260 employs the light source driver 230 to provide drive current to the LEDs so as to maintain a desired color profile 114.

In this manner, the real-time color calibration mechanism 260 can advantageously maintain a constant color profile 114 despite changes in conditions (e.g., temperatures) that may affect the performance of the light source 120 (e.g., amount of drive current provided to the LEDs or the operation of the LEDs).

Light Intensity Adjustment

In another embodiment, the color calibration mechanism 110 also includes a light source intensity adjustment mechanism 270 for receiving a resolution identifier 274 and selectively adjusting the intensity of the light source 120 based on the resolution identifier 274. The resolution identifier 274 specifies, for example, a resolution selected by a user for scanning a particular image. For example, when a high-resolution scan is selected, the resolution identifier 274 specifies a high resolution. In this case, the light source intensity adjustment mechanism 270 automatically increases the intensity of the light source 120 to provide a bright illumination light.

Similarly, when a low-resolution scan is selected, the resolution identifier 274 specifies a low resolution. In this case, the light source intensity adjustment mechanism 270 automatically decreases the intensity of the light source 120 to provide a darker illumination light. The light source intensity adjustment mechanism 270 can be coupled to the calibration color sensor 160 to detect the current illumination intensity and utilize the current intensity to selectively adjust the increase or decrease the intensity based on the selected scan resolution.

Color Profile Matching Processing

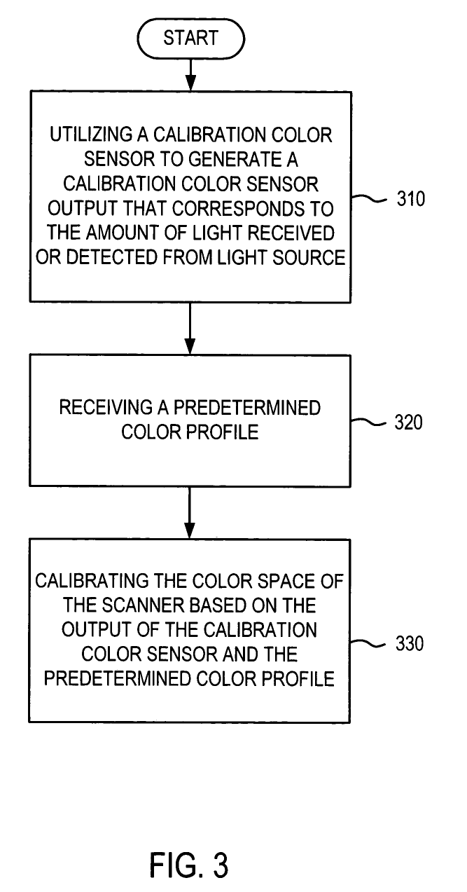

FIG. 3 is a flow chart illustrating the processing steps performed by the color profile matching mechanism according to one embodiment of the invention. Prior to utilizing an image sensor to generate an image sensor output that corresponds to the amount of light reflected from a target image (e.g., an image to be scanned), steps 310, 320, and 330 may be performed. It is noted that steps 310, 320, 330 described hereinbelow may be performed before each scan, at predetermined time intervals, or on a real-time basis.

In step 310, a calibration color sensor is utilized to generate a calibration color sensor output that corresponds to the amount of light generated by a light source and detected by the calibration color sensor. In step 320, a predetermined color profile is received. It is noted that the predetermined color profile may be generated by test data and stored in a memory prior to use of the scanner. The predetermined color profile can be, for example, the amount of red, green and blue expected from scanning the reference image. The predetermined color profile may be a color point on a CIE chromaticity diagram specified by a x-chromaticity coordinate and a y-chromaticity coordinate.

In step 330, calibrating the color space of the scanner based on the output of the calibration color sensor and the predetermined color profile is performed. For example, when the CCS output signal 224 matches the predetermined color profile 114, the color point 254 is maintained. However, when the CCS output signal 224 does not match the predetermined color profile 114, the color point 254 is selectively adjusted to change the output of the light source 120 to match the predetermined color profile 114.

The step of calibrating the color space of the scanner can include adjusting one or more light source control signals 118 so that the light source 120 produces a consistent light output. In one embodiment, the light source control signals 118 are light source drive currents, and adjusting one or more light source control signals 118 includes one of 1) adjusting a red LED control signal (e.g., a drive current for the red LED), 2) adjusting a green LED control signal (e.g., a drive current for the green LED), 3) adjusting a blue LED control signal (e.g., a drive current for the blue LED), or a combination thereof.

In another embodiment, step 330 includes the step of calibrating the color space of the scanner based on one or more of the following: the 1) output of the calibration color sensor, 2) output of the image sensor, and 3) the predetermined color profile.

In the foregoing specification, the invention has been described with reference to specific embodiments thereof. It will, however, be evident that various modifications and changes may be made thereto without departing from the broader scope of the invention. For example, it should be noted that the color calibration mechanism according to the invention is not limited to the arrangements shown in the figures. The specification and drawings are, accordingly, to be regarded in an illustrative rather than a restrictive sense.

What is claimed is:

1. A scanner that includes a color space comprising:
a light source that generates a light;
a light source calibration mechanism coupled to the light source; wherein the light source calibration mechanism includes;
a calibration color sensor to generate a calibration color sensor output;
wherein the light source calibration mechanism receives a predetermined color profile and calibrates the light source based on the output of the calibration color sensor and the predetermined color profile.

2. The scanner of claim 1 further comprising:
an image sensor that generates an image sensor output; wherein the image sensor is a contact image sensor;
wherein the light source calibration mechanism receives a predetermined color profile and calibrates the color space of the scanner based on the output of the calibration color sensor, the image sensor output, and the predetermined color profile.

3. The scanner of claim 1 wherein the light source includes a red light emitting diode, a green light emitting diode, and a blue light emitting diode.

4. The scanner of claim 3 wherein the predetermined color profile includes an amount of red light, an amount of green light, and an amount of blue light expected from scanning a reference image.

5. The scanner of claim 1 wherein the calibration color sensor includes one of a photo sensor, a photo diode, and a photo transistor.

6. The scanner of claim 1 further comprising:
a light source intensity adjustment mechanism coupled to the light source that receives a resolution identifier and selectively adjusts the intensity of the light source based on the resolution identifier.

7. The scanner of claim 1 further comprising:
a real time color calibration mechanism that maintains a color point on a real-time basis.

8. The scanner of claim 1 further comprising:
a light source driver that generates drive signals for the light source based on a color point;
wherein the light source includes a red light emitting diode, a green light emitting diode, and a blue light emitting diode; wherein each light emitting diode is driven by a respective drive signal;
wherein the color calibration mechanism selectively adjusts the color point in response to the output of the calibration color sensor, the image sensor output, and the predetermined color profile.

9. The scanner of claim 8 wherein the color point is a RGB ratio.

10. The scanner of claim 1 further comprising:
a light guide that mixes color light and directs the mixed light to an image to be scanned.

11. The scanner of claim 1 further comprising:
a lens array that receives light reflected from the scanned image and directs the reflected light to the image sensor.

12. An scanner comprising:
a) a contact image sensor (CIS);
b) a light source that includes a red light emitting diode (LED), a green light emitting diode (LED), and a blue light emitting diode (LED); wherein each light emitting diode is driven by a corresponding drive signal; and
c) a color calibration sensor that generates a color calibration sensor output;
d) an image sensor that generates an image sensor output; and
e) a color profile mapping mechanism for receiving a predetermined color profile, image sensor output, and color calibration sensor output and based thereon for selectively adjusting the light source drive signals.

13. The scanner of claim 12 wherein the image sensor output includes a RGB sensor output.

14. A method for calibrating the color space of a scanner comprising:
employing a color sensor to selectively control an illuminant color point;
performing a scan with an illuminant that utilizes the illuminant color point.

15. The method of claim 14 wherein the color measured by the color sensor is dependent on an illumination spectrum and the spectral response of the image color.

16. The method of claim 14 further comprising:
adjusting the intensity of the light source based on a selected scan resolution.

17. The method of claim 15 further comprising:
maintaining the illuminant color point on a real-time basis; and
adjusting the illuminant color point on a real-time basis.
